(19) United States
(12) Patent Application Publication
(10) Pub. No.: US 2025/0125087 A1
(43) Pub. Date: Apr. 17, 2025

(54) COIL COMPONENT

(71) Applicant: SAMSUNG ELECTRO-MECHANICS CO., LTD., Suwon-si (KR)

(72) Inventor: Kwang II PARK, Suwon-si (KR)

(73) Assignee: SAMSUNG ELECTRO-MECHANICS CO., LTD., Suwon-si (KR)

(21) Appl. No.: 18/824,048

(22) Filed: Sep. 4, 2024

(30) Foreign Application Priority Data
Oct. 13, 2023 (KR) 10-2023-0136419

(51) Int. Cl. H01F 27/32; H01F 27/29

(52) U.S. Cl. CPC H01F 27/32; H01F 27/29

(57) ABSTRACT

A coil component includes a body including a first surface, a second surface facing the first surface in a first direction, and a plurality of side surfaces connecting the first surface to the second surface, a support member disposed within the body and having a through-hole, and a coil disposed on at least one surface of the support member, wherein the support member includes a first layer, a second layer disposed on both surfaces of the first layer and contacting the coil, both ends of the coil extend to both side surfaces of the body facing each other in a second direction, respectively, and the first layer extends to one of both side surfaces of the body facing each other in a third direction.

### CROSS-REFERENCE TO RELATED APPLICATION(S)

This application claims benefit of priority to Korean Patent Application No. 10-2023-0136419 filed on Oct. 13, 2023 in the Korean Intellectual Property Office, the disclosure of which is incorporated herein by reference in its entirety.

### TECHNICAL FIELD

The present disclosure relates to a coil component.

Inductors, coil components, are representative passive electronic components used in electronic devices along with resistors and capacitors.

As electronic devices have been implemented with higher performance and have been miniaturized, electronic components used in electronic devices have also increased in number and have become miniaturized.

Recently, demand for electronic device products for electrical components of vehicles has increased due to the spread of electric vehicles. Accordingly, there are cases in which higher reliability is required, as compared to IT devices, and inductors that may improve Itemp characteristics, which are temperature characteristics, are required.

### SUMMARY

An aspect of the present disclosure is to improve Itemp characteristics related to high temperature reliability by easily dissipating heat occurring inside a coil component.

According to an aspect of the present disclosure, a coil component includes: a body including a first surface, a second surface facing the first surface in a first direction, and a plurality of side surfaces connecting the first surface to the second surface, the plurality of side surfaces include (i) a first side surface and a second side surface facing each other in a second direction and connecting the first surface to the second surface, and (ii) a third side surface and a fourth side surface facing each other in a third direction and connecting the first surface to the second surface, a support member disposed within the body and having a through-hole, and a coil disposed on at least one surface of the support member, the coil including (i) a first end extending to the first side surface, and (ii) a second end extending to the second side surface, wherein the support member includes a first layer, a second layer disposed on both surfaces of the first layer and contacting the coil, and the first layer extends to at least one selected from the third side surface and the fourth side surface.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first exemplary embodiment in the present disclosure;

FIG. 2 is an exploded perspective view schematically illustrating a support member and a coil in FIG. 1;

FIG. 3 is a top view of the coil component in FIG. 1;

FIG. 4 is a plan view without the coil in FIG. 3;

FIG. 5 is a cross-sectional view taken along line I-I′ in FIG. 1;

FIG. 6 is a cross-sectional view taken along line II-II′ in FIG. 1;

FIGS. 7A to 7F each illustrates an example of a first layer of the present disclosure;

FIG. 8 is a perspective view schematically illustrating a coil component according to a second exemplary embodiment in the present disclosure;

FIG. 9 is an exploded perspective view schematically illustrating a support member and a coil in FIG. 8;

FIG. 10 is a top view of the coil component in FIG. 8;

FIG. 11 is a plan view without the coil in FIG. 10;

FIG. 12 is a cross-sectional view taken along line III-III′ in FIG. 8;

FIGS. 13A and 13B are perspective views schematically illustrating coil components according to a third exemplary embodiment in the present disclosure and a modification thereof; and

FIGS. 14A to 14C are perspective views schematically illustrating coil components according to a fourth exemplary embodiment in the present disclosure and a modification thereof.

### DETAILED DESCRIPTION

The terms used in the present specification are merely used to describe particular exemplary embodiments and are not intended to limit the present disclosure. An expression used in the singular encompasses the expression of the plural, unless it has a clearly different meaning in the context. In the present specification, it is to be understood that the terms, such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. Also, throughout the specification, “on” means to be located above or below a target portion and does not necessarily mean to be located on the upper side with respect to the direction of gravity.

In addition, coupling does not mean only the case of direct physical contact between each component in a contact relationship, but it should be used as a concept that encompasses even a case in which another component intervenes between each component so that a component is in contact with the other component.

Since the size and thickness of each component illustrated in the drawings are arbitrarily illustrated for convenience of description, the present disclosure is not necessarily limited to the illustrated.

In the drawings, an X-direction may be defined as a first direction or thickness direction, a Y-direction may be defined as a second direction or length direction, and a Z-direction may be defined as a third direction or width direction.

Hereinafter, a coil component according to an exemplary embodiment in the present disclosure will be described in detail with reference to the accompanying drawings, and in the description with reference to the accompanying drawings, the same or corresponding components are assigned the same reference numerals and overlapping descriptions thereof are omitted.

Various types of electronic components are used in electronic devices, and various types of coil components may be appropriately used among these electronic components for purposes, such as noise cancellation.

In other words, coil components in electronic devices may be used as power inductors, high frequency (HF) inductors, general beads, GHz beads, common mode filters, and the like.

### First Exemplary Embodiment

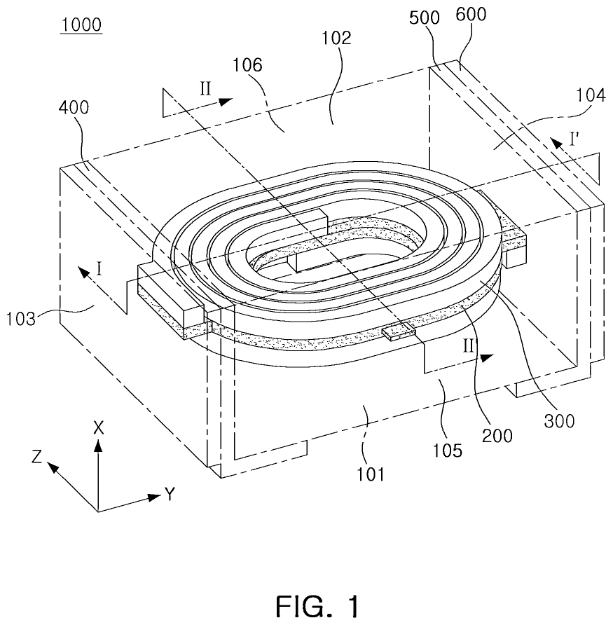

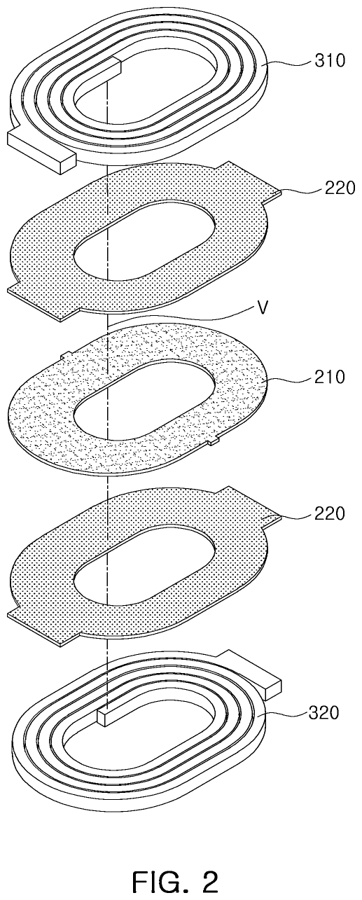

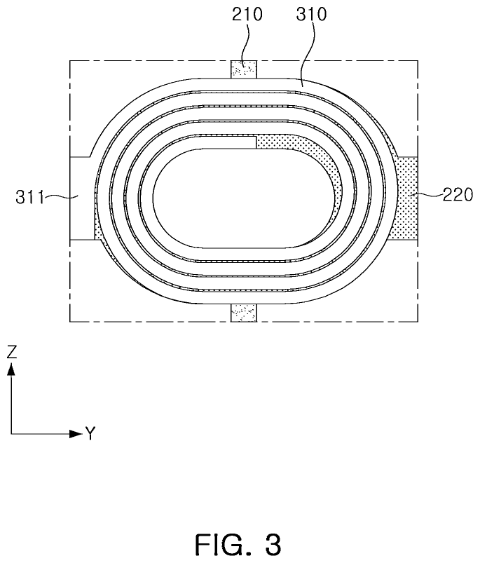

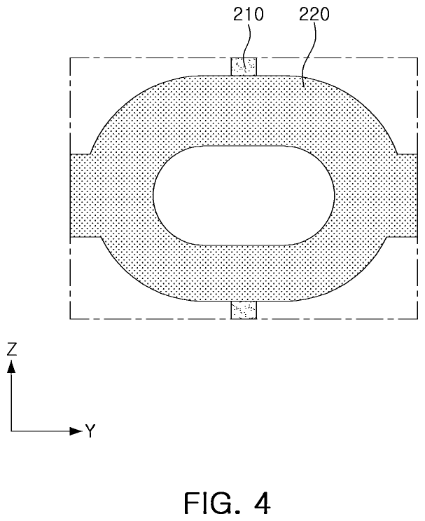

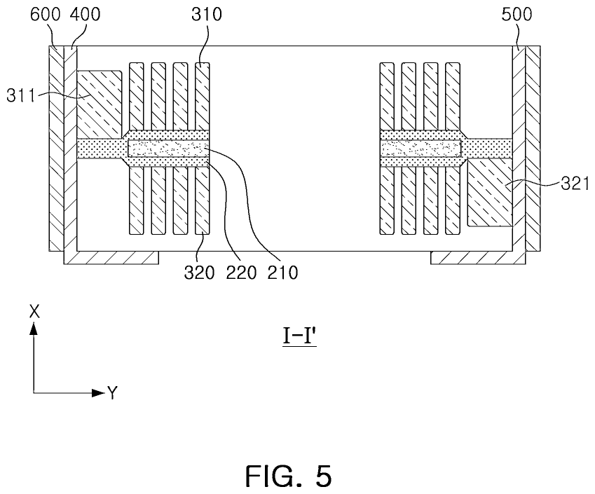

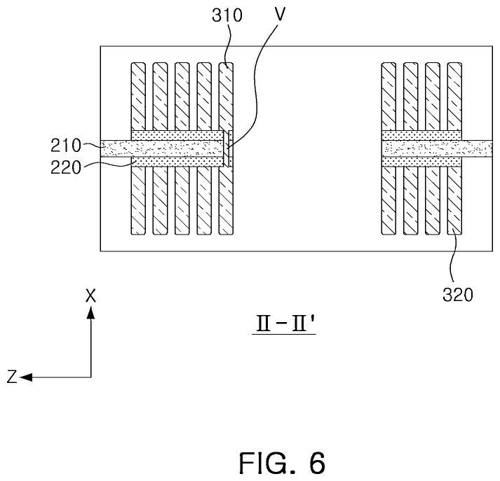

FIG. 1 is a perspective view schematically illustrating a coil component according to a first exemplary embodiment in the present disclosure. FIG. 2 is an exploded perspective view schematically illustrating a support member and a coil in FIG. 1. FIG. 3 is a top view of the coil component in FIG. 1. FIG. 4 is a plan view without the coil in FIG. 3. FIG. 5 is a cross-sectional view taken along line I-I′ in FIG. 1. FIG. 6 is a cross-sectional view taken along line II-II′ in FIG. 1.

Referring to FIGS. 1 to 5, a coil component 1000 according to the first exemplary embodiment in the present disclosure may include a body 100, a support member 200, a coil 300, and external electrodes 400 and 500 and may further include an insulating film (IF) and an insulating layer 600.

Hereinafter, the main components constituting the coil component 1000 according to the present exemplary embodiment is described in detail.

The body 100 forms the exterior of the coil component 1000 according to the present exemplary embodiment, and the support member 200 and the coil 300 are embedded in the body 100.

The body 100 may be formed as a whole into a hexahedral shape.

The body 100 includes a first surface 101 and a second surface 102 facing each other in a first direction (an X-direction), a first side surface 103 and a second side surface facing each other in a second direction (a Y-direction), and a third side surface 105 and a fourth side surface 106 facing each other in a third direction (a Z-direction). Each of the first to fourth side surfaces 103, 104, 105, and 106 of the body 100 correspond to a plurality of side surfaces of the body 100 connecting the first surface 101 and the second surface 102 of the body 100.

As an example, the body 100 may be formed such that the coil component 1000 according to the present exemplary embodiment, on which the external electrodes 400 and 500 are formed, has a length of 2.5 mm, a width of 2.0 mm, and a thickness of 0.8 mm, has a length of 2.0 mm, a width of 1.2 mm, and a thickness of 0.6 mm, has a length of 1.6 mm, a width of 0.8 mm, and a thickness of 0.6 mm, has a length of 1.6 mm, a width of 0.8 mm, and a thickness of 0.4 mm, has a thickness of 1.4 mm, a width of 1.2 mm, and a thickness of 0.65 mm, has a length of 1.0 mm, a width of 0.7 mm, and a thickness of 0.65 mm, has a length of 0.8 mm, a width of 0.4 mm, and a thickness of 0.65 mm, or has a length of 0.8 mm, a width of 0.4 mm, and a thickness of 0.5 mm, but is not limited thereto. Meanwhile, the aforementioned exemplary values for the length, width, and thickness of the coil component 1000 refer to values that do not reflect process errors, so the values in the range that may be recognized as process errors should be considered as the aforementioned exemplary values.

The body 100 may include a magnetic material and resin. Specifically, the body 100 may be formed by stacking one or more magnetic composite sheets in which a magnetic material is dispersed in a resin. However, the body 100 may have a structure other than the structure in which a magnetic material is dispersed in a resin. For example, the body 100 may be formed of a magnetic material, such as ferrite, or may be formed of a non-magnetic material.

The magnetic material may be ferrite or magnetic metal powder.

The ferrite may be at least one of, for example, spinel-type ferrite, such as Mg—Zn-based, Mn—Zn-based, Mn—Mg-based, Cu—Zn-based, Mg—Mn—Sr-based, and Ni—Zn-based ferrite, hexagonal ferrite, such as Ba—Zn-based, and Ba—Mg-based, Ba—Ni-based, Ba—Co-based, and Ba—Ni—Co-based ferrites, garnet-type ferrite, such as Y-based ferrite, and Li-based ferrite.

The magnetic metal powder may include at least one selected from the group consisting of iron (Fe), silicon (Si), chromium (Cr), cobalt (Co), molybdenum (Mo), aluminum (Al), niobium (Nb), copper (Cu), and nickel (Ni). For example, magnetic metal powder may include at least one of pure iron powder, Fe—Si-based alloy powder, Fe—Si—Al-based alloy powder, Fe—Ni-based alloy powder, Fe—Ni—Mo-based alloy powder, Fe—Ni—Mo—Cu-based alloy powder, Fe—Co-based alloy powder, Fe—Ni—Co-based alloy powder, Fe—Cr-based alloy powder, Fe—Cr—Si-based alloy powder, Fe—Si—Cu—Nb-based alloy powder, Fe—Ni—Cr-based alloy powder and Fe—Cr—Al-based alloy powder.

The magnetic metal powder may be amorphous or crystalline. For example, the magnetic metal powder may be Fe—Si—B—Cr based amorphous alloy powder, but is not limited thereto.

The ferrite and magnetic metal powder may each have an average diameter of about 0.1 μm to 30 μm, but are not limited thereto.

The body 100 may include two or more types of magnetic materials dispersed in a resin. Here, Different types of magnetic materials refer to magnetic materials dispersed in a resin and distinguished from each other by any one of average diameter, composition, crystallinity, and shape.

The resin may include epoxy, polyimide, liquid crystal polymer, etc., alone or in combination, but is not limited thereto.

The body 100 has a core 110 penetrating through the support member 200 and the coil 300. The core 110 may be formed by filling a through-hole of the support member 200 with a magnetic composite sheet, but is not limited thereto.

The support member 200 may be disposed within the body 100. The support member 200 is configured to support the coil 300.

An exemplary embodiment in the present disclosure proposes a structure of a coil component to easily dissipate heat generated inside the coil component as follows.

The support member 200 may include multiple layers. Specifically, the support member includes a first layer 210 and second layers 220 disposed on both sides of the first layer 210 and in contact with the coil.

The first layer 210 serves to dissipate heat generated when the coil component 1000 is used on a mounting board and/or heat transferred to the component externally. Specifically, when current flows in the coil 300, heat may be generated by a direct current resistance component (Rdc), and as the component become smaller and more integrated, the component may be more vulnerable to heat. In other words, high-temperature reliability of the coil component may be reduced. Itemp, an indicator of the high-temperature reliability of coil components, refers to a rated current for temperature rise. When the temperature rise is A40° C., the use of a current in excess of the corresponding current may result in damage to the component. The coil component according to an exemplary embodiment in the present disclosure may have improved Itemp characteristics associated with high-temperature reliability by improving the heat dissipation structure.

The first layer 210 of the present exemplary embodiment serves to efficiently dissipate heat to improve Itemp characteristics associated with high temperature reliability.

Referring to FIGS. 3 and 4, the arrangement of the first layer 210 is described in detail. FIG. 3 is a top view of the coil component in FIG. 1. FIG. 4 is a plan view without the coil in FIG. 3. For convenience, the external electrodes 400 and 500 and the insulating layer 600 are omitted in the drawing. The first layer 210 constitutes an intermediate layer of the support member 200. The first layer 210 may not be in direct contact with the coil 300. Instead, the first layer 210 may form a heat path for dissipating heat inside the coil component.

The first layer 210 may promote heat dissipation in the third direction (the Z-direction) of the body. Specifically, the first layer 210 may extend to either one or both side surfaces of the body facing each other in the third direction. That is, the first layer 210 may extend to the third side surface 105 or the fourth side surface 106.

The first layer 210 may be spaced apart from the first side surface 103 and the second side surface 104, which are both side surfaces of the body facing each other in the second direction (the Y-direction). This is contrary to the fact that the second layer 220 to be described below extends to the first side surface 103 and the second side surface 104. In the coil component according to the present exemplary embodiment, a path through which current flows and a path through which heat is dissipated are separated from each other, thereby enabling efficient dissipation of heat.

Thermal conductivity of the first layer 210 may be higher than that of the second layer 220. Thermal conductivity may be measured by a heat flow meter. Other methods and/or tools appreciated by one of ordinary skill in the art, even if not described in the present disclosure, may also be used.

The first layer 210 may include an insulating material and a filler. Various types of resins may be used as insulating materials. Specifically, the first layer 210 may be formed of an insulating material including a thermosetting insulating resin, such as an epoxy resin, a thermoplastic insulating resin, such as polyimide, or a photosensitive insulating resin.

Compared to the second layer 220, the first layer 210 may further include a filler. The filler may include at least one selected from the group consisting of carbon nanotubes, graphene, conductive polymers, Cu (copper), Ag (silver), and Au (gold). In particular, when carbon nanotube is used, it may form a CNT epoxy composite with an insulating material. However, the present disclosure is not limited thereto.

The filler may include a material having high thermal conductivity and may promote dissipation of heat in the third direction (the Z-direction) of the body 100.

The second layer 220 may be in contact with the coil 300. That is, the second layer 220 is configured to directly support the coil 300. Specifically, the second layer 220 is disposed on the upper and lower surfaces of the first layer 210 and constitutes the outermost layers of the support member 200.

The arrangement of the second layer 220 is described in detail with reference to FIGS. 3 and 4. The second layer 220 may extend to both surfaces of the body facing each other in the second direction (the Y-direction). As to be described below, since both ends of the coil 300 extend to the first side surface 103 and the second side surface 104, the second layer 220 may extend to both side surfaces of the body facing in the second direction (the Y-direction) to support both ends of the coil 300. However, the present disclosure is not limited thereto, and the second layer 220 may not extend to both side surfaces of the body facing each other in the second direction (the Y-direction).

The second layer 220 may be spaced apart from both side surfaces 105 and 106 of the body facing each other in the third direction. That is, only the first layer 210 of the support member 200 may extend to the third side surface 105 or the fourth side surface 106 of the body.

The second layer 220 may be formed of an insulating material including at least one of a thermosetting insulating resin, such as an epoxy resin, a thermoplastic insulating resin, such as polyimide, and a photosensitive insulating resin or may be formed of an insulating material obtained by impregnating an insulating resin with a reinforcing material, such as glass fiber or an inorganic filler. For example, the second layer 220 may be formed by stacking insulating films on each of both sides of the first layer 210. The insulating film may be a normal non-photosensitive insulating film, such as Ajinomoto build-up film (ABF) or prepreg, or a photosensitive insulating film, such as dry-film or PID. However, the present disclosure is not limited thereto, and the insulating film may be formed by applying a liquid insulating resin and then curing the same.

The second layer 220 may not include the filler of the aforementioned first layer 210. That is, the second layer 220 may not include carbon nanotubes, graphene, conductive polymers, Cu (copper), Ag (silver), and Au (gold).

As described above, since the arrangements of the first layer 210 and the second layer 220 are slightly different, a thickness of the support member 200 may vary depending on a position.

Specifically, a thickness relationship may be different within a region of the support member 200 that directly supports the coil 300. Referring to FIG. 5, regions supporting both ends 311 and 321 of the coil may be thinner than other regions. The second layer 220 extends to the first and second side surfaces 103 and 104 of the body, whereas the first layer 210 does not extend to the first and second side surfaces 103 and 104 of the body, and thus, a thickness difference may occur. Accordingly, both ends 311 and 321 of the coil may be disposed closer to the center of the body 100 based on the first direction (the X-direction) of the body 100 than the coil 300 excluding both ends. That is, an upper surface of the end 311 of the first coil pattern may be located lower than an upper surface of the first coil pattern 310 excluding the end. Similarly, a lower surface of the end 321 of the second coil pattern may be located higher than a lower surface of the second coil pattern 320 excluding the end.

The regions of the support member 200 that directly support the coil 300, excluding both ends of the coil, may be thicker than regions that do not directly support the coil 300. Referring to FIG. 6, a portion of the first layer 210 extends to the third and fourth side surfaces 105 and 106 of the body, without supporting the coil 300. Since the second layer 220 is not disposed in the corresponding portion of the first layer 210, a thin region of the support member 200 may be formed.

The coil 300 is disposed on the support member 200. The coil 300 is embedded in the body 100 and exhibits the characteristics of the coil component. For example, when the coil component 1000 of the present exemplary embodiment is used as a power inductor, the coil 300 may serve to stabilize power of an electronic device by storing an electric field as a magnetic field and maintaining an output voltage.

The coil 300 is formed on at least one of two opposing surfaces of the support member 200 and forms at least one turn. In the present exemplary embodiment, the coil 300 may include coil patterns 310 and 320 and a via V.

Referring to FIGS. 1 to 3, each of the first coil pattern 310 and the second coil pattern 320 may be disposed on both surfaces of the support member 200 facing each other and may be in the form of a planar spiral forming at least one turn about the core 110 of the body 100 as an axis. For example, based on the direction in FIG. 1, the first coil pattern 310 is disposed on the upper surface of the support member 200 to form at least one turn about the core 110 as an axis. The second coil pattern 320 is disposed on the lower surface of the support member 200 to form at least one turn about the core 110 as an axis.

Both ends of the coil patterns 310 and 320 may extend to both side surfaces of the body facing each other in the second direction (the Y-direction). That is, the end 311 of the first coil pattern and the end 321 of the second coil pattern may extend to the first side surface 103 and the second side surface 104 of the body 100, respectively. The end 311 of the first coil pattern may extend to the first side surface 103 of the body 100 and be connected to the first external electrode 400. In addition, the end 321 of the second coil pattern may extend to the second side surface 104 of the body 100 and be connected to the second external electrode 500.

The coil 300 may further include the via V connecting the first coil pattern 310 to the second coil pattern 320. Specifically, the via V may connect inner ends of the innermost turns of the first and second coil patterns 310 and 320 through both the first layer 210 and the second layer 220 of the support member 200. Accordingly, a signal input to the first external electrode 400 may be output to the second external electrode 500 through the first coil pattern 310, the via V, and the second coil pattern 320. Through this structure, each component of the coil 300 may function as a single coil connected between the first and second external electrodes 400 and 500.

At least one of the coil patterns 310 and 320 and the via V may include at least one conductive layer.

For example, when the first coil pattern 310 and the via V are formed by plating on the upper surface (based on the direction in FIG. 1) of the support member 200, the first coil pattern 310 and the via V may each include a seed layer and an electroplating layer. The seed layer may be formed by electroless plating or a vapor deposition method, such as sputtering. Each of the seed layer and the electroplating layer may have a single-layer structure or a multilayer structure. The electroplating layer having a multilayer structure may be formed as a conformal film structure in which one electroplating layer is covered by another electroplating layer or another electroplating layer is stacked only on one surface of one electroplating layer. The seed layer of the first coil pattern 310 and the seed layer of the via V may be formed integrally, so that no boundary may be formed therebetween, but the present disclosure is not limited thereto. The electroplating layer of the first coil pattern 310 and the electroplating layer of the via V may be integrally formed so that no boundary may be formed therebetween, but the present disclosure is not limited thereto.

The coil patterns 310 and 320 and vias V may each include a conductive material, such as copper (Cu), aluminum (Al), silver (Ag), tin (Sn), gold (Au), nickel (Ni), lead (Pb), titanium (Ti), chromium (Cr), molybdenum (Mo), or alloys thereof, but is not limited thereto.

The external electrodes 400 and 500 may be disposed on the first side surface 103 and the second side surface 104 of the body 100 and connected to both ends of the coil 300, respectively. Specifically, the first external electrode 400 may be disposed on the first side surface 103 of the body 100 and connected to the end 311 of the first coil pattern. In addition, the second external electrode 500 may be disposed on the second side surface 104 of the body 100 and connected to the end 321 of the second coil pattern.

The external electrodes 400 and 500 may extend to the first surface 101 of the body 100. When the coil component 1000 according to the present exemplary embodiment is mounted on a printed circuit board, the external electrodes 400 and 500 electrically connect the coil component 1000 to the printed circuit board, etc. For example, the external electrodes 400 and 500 spaced apart from each other on the first surface 101 of the body 100 may be electrically connected to a connection portion of the printed circuit board.

The external electrodes 400 and 500 may be formed of a conductive material, such as copper (Cu), aluminum (Al), silver (Ag), tin (Sn), gold (Au), nickel (Ni), lead (Pb), chromium (Cr), titanium (Ti) or alloys thereof, but is not limited thereto.

Each of the external electrodes 400 and 500 may be formed of multiple layers. For example, the first external electrode 400 may include a first layer in contact with the end 311 of the first coil pattern and a second layer disposed on the first layer. Here, the first layer may be a conductive resin layer including conductive powder including at least one of copper (Cu) and silver (Ag) and an insulating resin or may be a copper (Cu) plating layer. The second layer may have a double-layer structure including a nickel (Ni) plating layer/tin (Sn) plating layer.

Although not shown in the drawing, the insulating film IF may be disposed between the coil 300 and the body 100 to cover the coil 300. The insulating film IF may be formed on the surfaces of the support member 200 and the coil 300. The insulating film IF is used to insulate the coil 300 from the body 100 and may include a known insulating material, such as parylene, but is not limited thereto. The insulating film IF may be formed by a method, such as vapor deposition, but is not limited thereto, and may be formed by stacking an insulating film on both sides of the support member 200.

Meanwhile, the coil component 1000 according to the present exemplary embodiment may further include an insulating layer 600 covering the first and second side surfaces 103 and 104 of the body 100.

For example, the insulating layer may be formed by applying an insulating material including an insulating resin to the surface of the body 100 and curing the same. In this case, the insulating layer may include at least one of a thermoplastic resin, such as polystyrene-based, vinyl acetate-based, polyester-based, polyethylene-based, polypropylene-based, polyamide-based, rubber-based, and acrylic-based resin, a thermosetting resin, such as phenol-based, epoxy-based, urethane-based, melamine-based, and alkyd-based resin, and a photosensitive insulating resin.

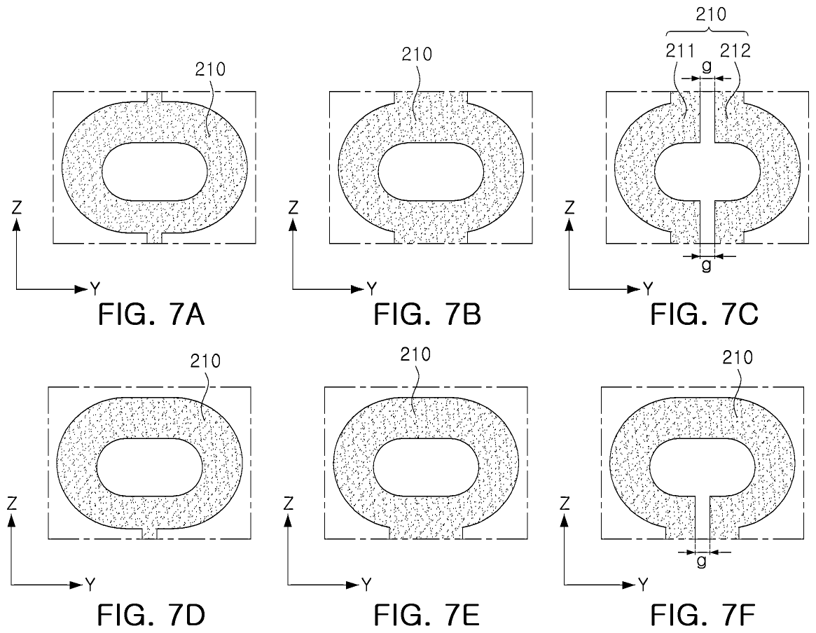

FIGS. 7A to 7F each illustrates an example of a first layer of the present disclosure.

Referring to FIGS. 7A to 7F, the first layer 210 may extend to both the third side surface 105 and the fourth side surface 106 or may extend to either the third side surface 105 or the fourth side surface 106. In addition, a gap may be formed between surfaces of the first layer 210 extending to the side surfaces 105 and 106 of the body. The first layer 210 may include a first portion 211 and a second portion 212 spaced apart from each other in the second direction (the Y-direction) with respect to the through-hole.

### Second Exemplary Embodiment

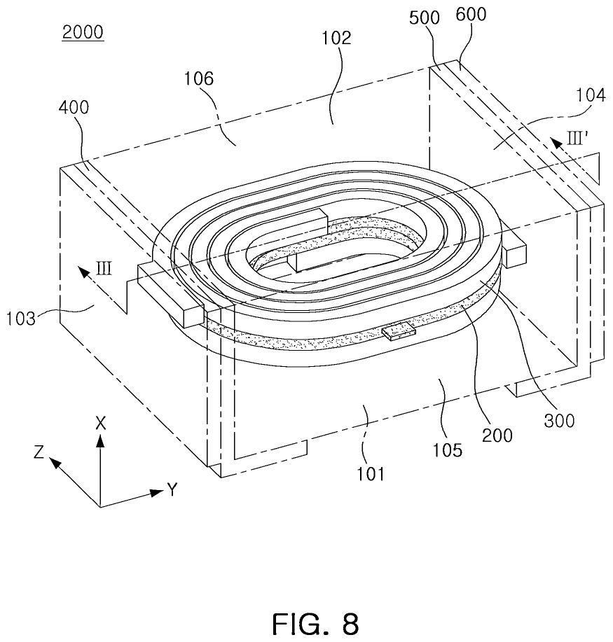

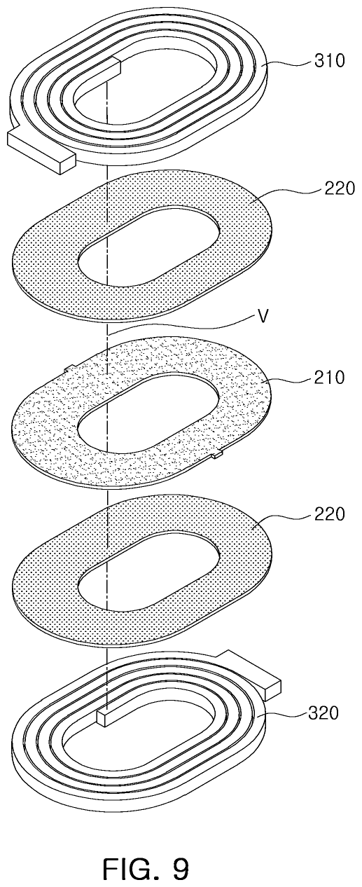

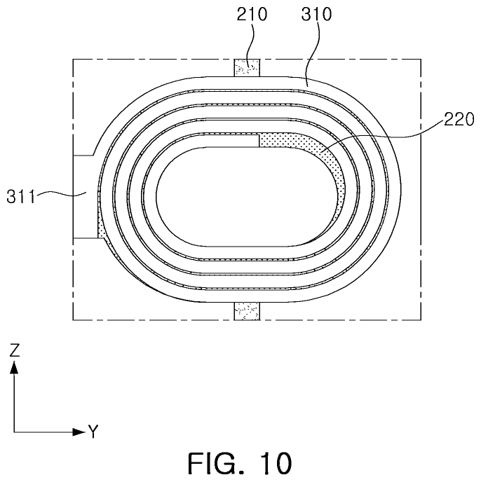

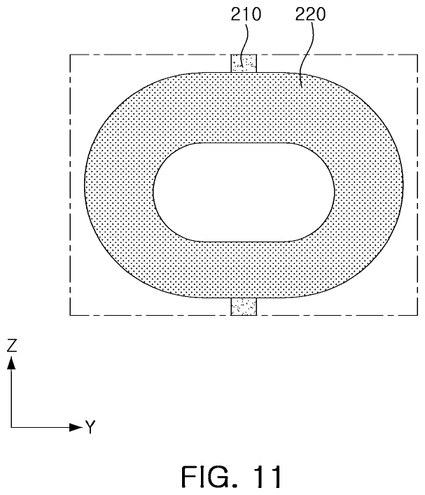

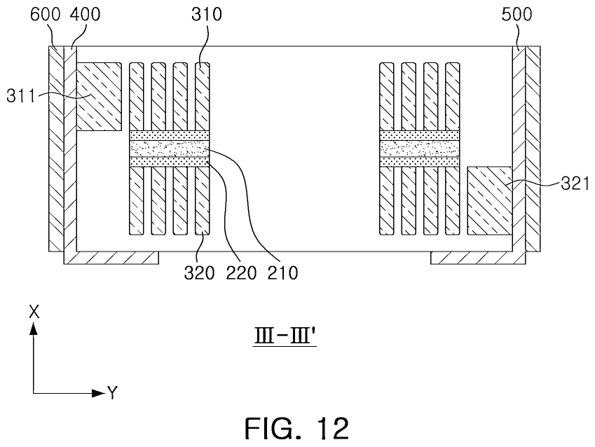

FIG. 8 is a perspective view schematically illustrating a coil component according to a second exemplary embodiment in the present disclosure. FIG. 9 is an exploded perspective view schematically illustrating a support member and a coil in FIG. 8. FIG. 10 is a top view of the coil component in FIG. 8. FIG. 11 is a plan view without the coil in FIG. 10. FIG. 12 is a cross-sectional view taken along line III-III′ in FIG. 8.

The coil component 2000 according to the second exemplary embodiment has a different arrangement of the second layer 220 compared to the coil component 1000 according to the first exemplary embodiment. Specifically, after the first and second coil patterns 310 and 320 are formed, a portion of the support member 200 may be removed. Accordingly, the second layer 220 does not extend to both side surfaces of the body 100 facing each other in the second direction (the Y-direction). That is, the second layer 220 does not extend to the first side surface 103 and the second side surface 104 of the body 100. A portion of the body 100 may be filled in place of the removed portion of the support member 200.

As described above in the first exemplary embodiment, since the second layer 220 does not extend to both side surfaces of the body 100 facing each other in the third direction (the Z-direction), the second layer 220 is spaced apart from all the side surfaces 103, 104, 105, and 106 of the body 100.

As described above, since the second layer 220 does not extend to the first side surface 103 and the second side surface 104 of the body 100, at least a portion of each of the ends 311 and 321 of the first and second coil patterns may not be in contact with the second layer 220.

The end 311 of the first coil pattern may be disposed on the same level as that of the first coil pattern 310 except for the end. That is, an upper surface of the end 311 of the first coil pattern may have the same height as that of the upper surface of the first coil pattern 310 excluding the end. Similarly, a lower surface of the end 321 of the second coil pattern may have the same height as that of the lower surface of the second coil pattern 320 excluding the end.

Hereinafter, other descriptions of the corresponding exemplary embodiment are the same as the description of the first exemplary embodiment and are therefore omitted.

### Third Exemplary Embodiment

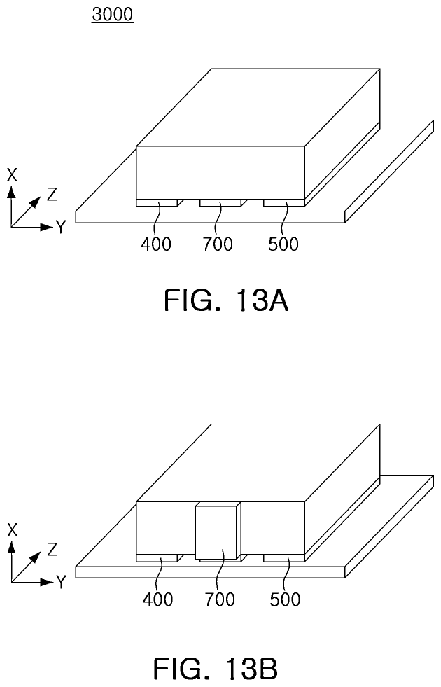

FIGS. 13A and 13B are perspective views schematically illustrating coil components according to a third exemplary embodiment in the present disclosure and a modification thereof.

Compared to the coil component 1000 according to the first exemplary embodiment, a coil component 3000 according to the third exemplary embodiment further includes a third external electrode 700.

The third external electrode 700 is disposed on the first surface 101 of the body 100 to improve heat dissipation characteristics of the coil component.

Referring to FIG. 13A, the third external electrode 700 is disposed on the first surface 101 of the body 100 and between the first and second external electrodes 400 and 500.

Referring to FIG. 13B, the third external electrode 700 may extend to the third side surface 105 of the body.

The third external electrode 700 may include at least one of a conductive resin layer and an electroplating layer. The conductive resin layer may be formed by paste printing, etc. and may include one or more conductive metals selected from the group consisting of copper (Cu), nickel (Ni), and silver (Ag) and a thermosetting resin. The electroplating layer may include one or more selected from the group consisting of nickel (Ni), copper (Cu), and tin (Sn).

Hereinafter, other descriptions of the corresponding exemplary embodiment are the same as the description of the first exemplary embodiment and are therefore omitted.

### Exemplary Embodiment 4

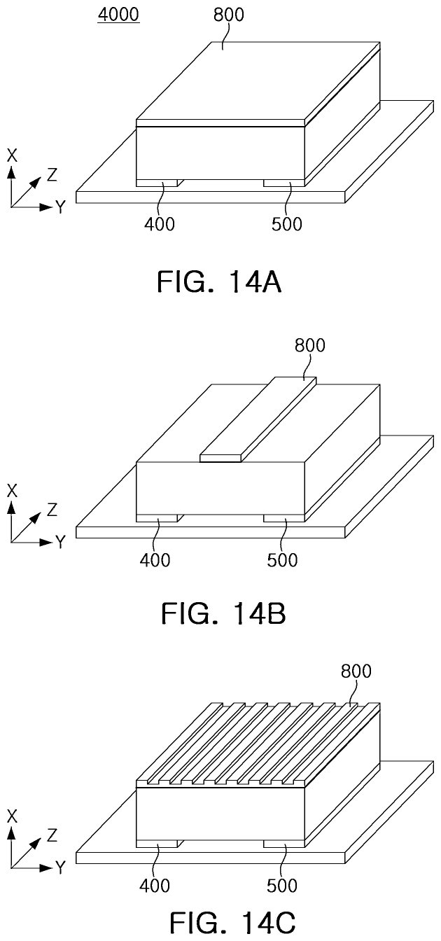

FIGS. 14A to 14C are perspective views schematically illustrating coil components according to a fourth exemplary embodiment in the present disclosure and a modification thereof.

Compared to the coil component 1000 according to the first exemplary embodiment, a coil component 4000 according to the fourth exemplary embodiment further includes a pad 800.

The pad 800 is disposed on the second surface 102 of the body 100 to improve heat dissipation characteristics of the coil component.

Referring to FIG. 14A, the pad 800 may cover the entire second surface 102 of the body 100.

Referring to FIG. 14B, the pad 800 may cover a portion of the second surface 102 of the body 100.

Referring to FIG. 14C, the pad 800 may cover the entire second surface 102 of the body 100 and may have a concave-convex shape.

The pad 800 may include at least one of a conductive resin layer and an electroplating layer. The conductive resin layer may be formed by paste printing, etc. and may include one or more conductive metals selected from the group consisting of copper (Cu), nickel (Ni), and silver (Ag) and a thermosetting resin. The electroplating layer may include one or more selected from the group consisting of nickel (Ni), copper (Cu), and tin (Sn).

Hereinafter, other descriptions of the corresponding exemplary embodiment are the same as the description of the first exemplary embodiment and are therefore omitted.

According to one aspect of the present disclosure, heat generated inside the coil component may be easily dissipated, thereby improving Itemp characteristics associated with high temperature reliability.

While example exemplary embodiments have been shown and described above, it will be apparent to those skilled in the art that modifications and variations could be made without departing from the scope of the present disclosure as defined by the appended claims.

What is claimed is:

1. A coil component comprising:
a body including a first surface, a second surface facing the first surface in a first direction, and a plurality of side surfaces connecting the first surface to the second surface, the plurality of side surfaces include (i) a first side surface and a second side surface facing each other in a second direction and connecting the first surface to the second surface, and (ii) a third side surface and a fourth side surface facing each other in a third direction and connecting the first surface to the second surface;
a support member disposed within the body and having a through-hole; and
a coil disposed on at least one surface of the support member, the coil including (i) a first end extending to the first side surface, and (ii) a second end extending to the second side surface,
wherein the support member includes a first layer, and a second layer disposed on both surfaces of the first layer and contacting the coil,
and
the first layer extends to at least one selected from the third side surface and the fourth side surface.

2. The coil component of claim 1, wherein
the first layer includes a resin and a filler,
the second layer includes the resin, and
the filler includes at least one selected from the group consisting of carbon nanotube, graphene, a conductive polymer, Cu (copper), Ag (silver), and Au (gold).

3. The coil component of claim 1, wherein thermal conductivity of the first layer is higher than thermal conductivity of the second layer.

4. The coil component of claim 1, wherein the first layer does not directly contact the coil.

5. The coil component of claim 1, wherein the first layer is spaced apart from the first side surface and the second side surface.

6. The coil component of claim 1, wherein the second layer extends to the first side surface and the second side surface.

7. The coil component of claim 1, wherein the second layer is spaced apart from the third side surface and the fourth side surface.

8. The coil component of claim 7, wherein the second layer is spaced apart from the first to fourth side surfaces.

9. The coil component of claim 1, wherein the coil includes a first coil pattern disposed on a first surface of the support member, a second coil pattern disposed on a second surface of the support member facing the first surface of the support member, and a via connecting the first coil pattern to the second coil pattern through the support member.

10. The coil component of claim 9, wherein the via penetrates through both the first layer and the second layer.

11. The coil component of claim 1, wherein the first layer extends to the third side surface and the fourth side surface.

12. The coil component of claim 11, wherein the first layer includes a first portion and a second portion spaced apart from each other in the second direction with respect to the through-hole.

13. The coil component of claim 1, further comprising a gap between surfaces of the first layer extending to the third side surface and the fourth side surface.

14. The coil component of claim 1, further comprising:
first and second external electrodes connected to the first end and the second end of the coil, respectively, and disposed on the first side surface and the second side surface,
wherein the first and second external electrodes extend to the first surface of the body.

15. The coil component of claim 14, further comprising a third external electrode disposed on the first surface of the body and disposed between the first and second external electrodes.

16. The coil component of claim 14, further comprising a pad disposed on the second surface of the body.

17. The coil component of claim 2, wherein the resin includes epoxy.

18. The coil component of claim 2, wherein the second layer is free of the filler.

19. The coil component of claim 1, wherein the first layer extends to either the third side surface or the fourth side surface.
